(19) United States
(12) Patent Application Publication
(10) Pub. No.: US 2025/0133431 A1
(43) Pub. Date: Apr. 24, 2025

(54) MEASUREMENT PRIORITIZATION BY CELL

(71) Applicant: QUALCOMM Incorporated, San Diego, CA (US)

(72) Inventors: Ishdeep Singh JUNEJA, Hyderabad (IN); Nazmul ISLAM, Littleton, MA (US); Nitish NAGAR, Varanasi (IN); Kunal SONI, Churu (IN); Sambit BEHURA, Hyderabad (IN); Varun WALIA, Hyderabad (IN)

(21) Appl. No.: 18/491,234

(22) Filed: Oct. 20, 2023

(51) Int. Cl. H04W 24/10; H04W 24/08; H04W 48/16

(52) U.S. Cl. CPC H04W 24/10; H04W 24/08; H04W 48/16

(57) ABSTRACT

Various aspects of the present disclosure generally relate to wireless communication. In some aspects, a user equipment (UE) may receive an indication of a set of synchronization signal blocks (SSBs). The UE may receive an indication of a set of physical cell identifiers (PCIs) associated with the set of SSBs, wherein the set of PCIs are stored in association with the set of SSBs. The UE may refrain from performing a measurement on a first SSB, in the set of SSBs, wherein the first SSB is associated with a same PCI, in the set of PCIs, as a second SSB that is included in the set of SSBs and is measured. Numerous other aspects are described.

### FIELD OF THE DISCLOSURE

Aspects of the present disclosure generally relate to wireless communication and to techniques and apparatuses for measurement prioritization by cell.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of a set of synchronization signal blocks (SSBs). The method may include receiving an indication of a set of physical cell identifiers (PCIs) associated with the set of SSBs, wherein the set of PCIs are stored in association with the set of SSBs. The method may include refraining from performing a measurement on a first SSB, in the set of SSBs, wherein the first SSB is associated with a same PCI, in the set of PCIs, as a second SSB that is included in the set of SSBs and is measured.

Some aspects described herein relate to a method of wireless communication performed by a UE. The method may include receiving an indication of a set of SSBs. The method may include receiving an indication of a set of PCIs associated with the set of SSBs, wherein the set of PCIs are stored in association with the set of SSBs. The method may include performing measurements on a subset of SSBs, in the set of SSBs, wherein the subset is selected to maximize a quantity of PCIs, in the set of PCIs, that are associated with the subset of SSBs.

Some aspects described herein relate to an apparatus for wireless communication at a UE. The apparatus may include one or more memories and one or more processors coupled to the one or more memories. The one or more memories may comprise instructions executable by the one or more processors to cause the UE to receive an indication of a set of SSBs. The one or more memories may comprise instructions executable by the one or more processors to cause the UE to receive an indication of a set of PCIs associated with the set of SSBs, wherein the set of PCIs are stored in association with the set of SSBs. The one or more memories may comprise instructions executable by the one or more processors to cause the UE to refrain from performing a measurement on a first SSB, in the set of SSBs, wherein the first SSB is associated with a same PCI, in the set of PCIs, as a second SSB that is included in the set of SSBs and is measured.

Some aspects described herein relate to an apparatus for wireless communication at a UE. The apparatus may include one or more memories and one or more processors coupled to the one or more memories. The one or more memories may comprise instructions executable by the one or more processors to cause the UE to receive an indication of a set of SSBs. The one or more memories may comprise instructions executable by the one or more processors to cause the UE to receive an indication of a set of PCIs associated with the set of SSBs, wherein the set of PCIs are stored in association with the set of SSBs. The one or more memories may comprise instructions executable by the one or more processors to cause the UE to perform measurements on a subset of SSBs, in the set of SSBs, wherein the subset is selected to maximize a quantity of PCIs, in the set of PCIs, that are associated with the subset of SSBs.

Some aspects described herein relate to an apparatus for wireless communication. The apparatus may include means for receiving an indication of a set of SSBs. The apparatus may include means for receiving an indication of a set of PCIs associated with the set of SSBs, wherein the set of PCIs are stored in association with the set of SSBs. The apparatus may include means for refraining from performing a measurement on a first SSB, in the set of SSBs, wherein the first SSB is associated with a same PCI, in the set of PCIs, as a second SSB that is included in the set of SSBs and is measured.

Some aspects described herein relate to an apparatus for wireless communication. The apparatus may include means for receiving an indication of a set of SSBs. The apparatus may include means for receiving an indication of a set of PCIs associated with the set of SSBs, wherein the set of PCIs are stored in association with the set of SSBs. The apparatus may include means for performing measurements on a subset of SSBs, in the set of SSBs, wherein the subset is selected to maximize a quantity of PCIs, in the set of PCIs, that are associated with the subset of SSBs.

Some aspects described herein relate to a non-transitory computer-readable medium that stores one or more instructions for wireless communication. The one or more instructions, when executed by one or more processors of a UE, may cause the UE to receive an indication of a set of SSBs. The one or more instructions, when executed by the one or more processors of the UE, may cause the UE to receive an indication of a set of PCIs associated with the set of SSBs, wherein the set of PCIs are stored in association with the set of SSBs. The one or more instructions, when executed by the one or more processors of the UE, may cause the UE to refrain from performing a measurement on a first SSB, in the set of SSBs, wherein the first SSB is associated with a same PCI, in the set of PCIs, as a second SSB that is included in the set of SSBs and is measured.

Some aspects described herein relate to a non-transitory computer-readable medium that stores one or more instructions for wireless communication. The one or more instructions, when executed by one or more processors of a UE, may cause the UE to receive an indication of a set of SSBs. The one or more instructions, when executed by the one or more processors of the UE, may cause the UE to receive an indication of a set of PCIs associated with the set of SSBs, wherein the set of PCIs are stored in association with the set of SSBs. The one or more instructions, when executed by the one or more processors of the UE, may cause the UE to perform measurements on a subset of SSBs, in the set of SSBs, wherein the subset is selected to maximize a quantity of PCIs, in the set of PCIs, that are associated with the subset of SSBs.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment in a wireless network, in accordance with the present disclosure.

FIG. 3 is a diagram illustrating an example of a synchronization signal hierarchy, in accordance with the present disclosure.

FIG. 4 is a diagram illustrating an example associated with measurement prioritization by cell, in accordance with the present disclosure.

FIG. 5 is a diagram illustrating an example associated with measurement rounds, in accordance with the present disclosure.

FIGS. 6 and 7 are diagrams illustrating example processes associated with measurement prioritization by cell, in accordance with the present disclosure.

FIGS. 8 and 9 are diagrams of example apparatuses for wireless communication, in accordance with the present disclosure.

### DETAILED DESCRIPTION

A user equipment (UE) may perform measurements (e.g., layer 1 (L1) measurements and/or layer 3 (L3) measurements) while connected to a wireless network. Many measurements are performed on a synchronization signal block (SSB).

As used herein, “SSB” refers to signals that carry information used for initial network acquisition and synchronization, such as primary synchronization signal (PSS), a secondary synchronization signal (SSS), a physical broadcast channel (PBCH), and a PBCH demodulation reference signal (DMRS). Accordingly, an SSB is sometimes referred to as a synchronization signal/PBCH (SS/PBCH) block.

The network may configure many measurements for a UE. For example, in standards promulgated by the Third Generation Partnership Project (3GPP), up to 64 MeasObjects may be transmitted to a UE. When the network transmits a lot of MeasObjects to the UE, memory overhead increases at the UE. Additionally, each measurement that is performed by the UE costs processing resources and power at the UE. When the UE moves between frequencies to perform different measurements, power consumption is further increased, along with latency. Therefore, the UE may ignore some MeasObjects from the network. However, ignoring some MeasObjects may reduce an ability for the network to perform handover, and the UE may blindly perform cell re-selection when the UE moves out of range of a current serving cell, which increases power and processing resource cost.

Some UEs, such as smart devices (such as smart watches and/or fitness trackers, among other examples), industrial sensors, and/or video surveillance devices, among other examples, may have smaller power sources (e.g., batteries) and smaller memories than other UEs. Such UEs are sometimes referred to as reduced capacity UEs (“RedCap UEs”) and/or “NR-light UEs.” Accordingly, RedCap UEs in particular may ignore some MeasObjects from the network. However, as described above, ignoring some MeasObjects may reduce an ability for the network to perform handover, which increases power and processing resource cost on the RedCap UE.

Various aspects relate generally to wireless communication and more particularly to storing a set of physical cell identifiers (PCIs) in association with a set of SSBs. For example, a UE (such as a RedCap UE) may receive an indication of the set of SSBs (e.g., in MeasObjects from a network) and may decode the set of PCIs from the set of SSBs. Some aspects more specifically relate to storing an indication of whether each SSB is a cell-defining SSB (CD-SSB) or a non-cell-defining SSB (NCD-SSB) in association with the set of SSBs. As used herein, “CD-SSB” refers to an SSB that indicates a subcarrier offset (e.g., referred to as k_{SSB}) satisfying a threshold (e.g., defined in 3GPP specifications). “NCD-SSB” refers to an SSB that does not indicate a subcarrier offset or that indicates a subcarrier offset failing to satisfy a threshold.

Particular aspects of the subject matter described in this disclosure can be implemented to realize one or more of the following potential advantages. In some examples, because the UE is aware of which SSBs are associated with which PCIs, the UE may perform a plurality of measurement rounds, with each measurement round including a different subset of SSBs that are still associated with all (or most) of the PCIs. Therefore, the UE may reduce power and processing resource cost in each measurement round while ensuring that the network is still able to effectively perform handover of the UE. Additionally, or alternatively, the UE may discard MeasObjects associated with duplicate PCIs and/or associated with NCD-SSBs. Therefore, the UE may reduce memory overhead systematically, without inhibiting the network's ability to effectively perform handover of the UE. Additionally, or alternatively, the UE may further relax radio resource management (RRM) requirements by ignoring MeasObjects associated with NCD-SSBs when radio conditions are good. Therefore, the UE may reduce power and processing resource cost. Additionally, or alternatively, for a RedCap UE, the UE may merge a table indicating which PCIs are associated with NCD-SSBs with a table indicating cells on which the UE most recently camped (e.g., also referred to as an “Acq db”), such that the UE prioritizes cells that are associated with NCD-SSBs (and thus are RedCap compatible). The UE thus experiences improved quality and reliability of communications on RedCap compatible cells while conserving power and processing resources that otherwise would have been wasted in camping on a non-RedCap compatible cell.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

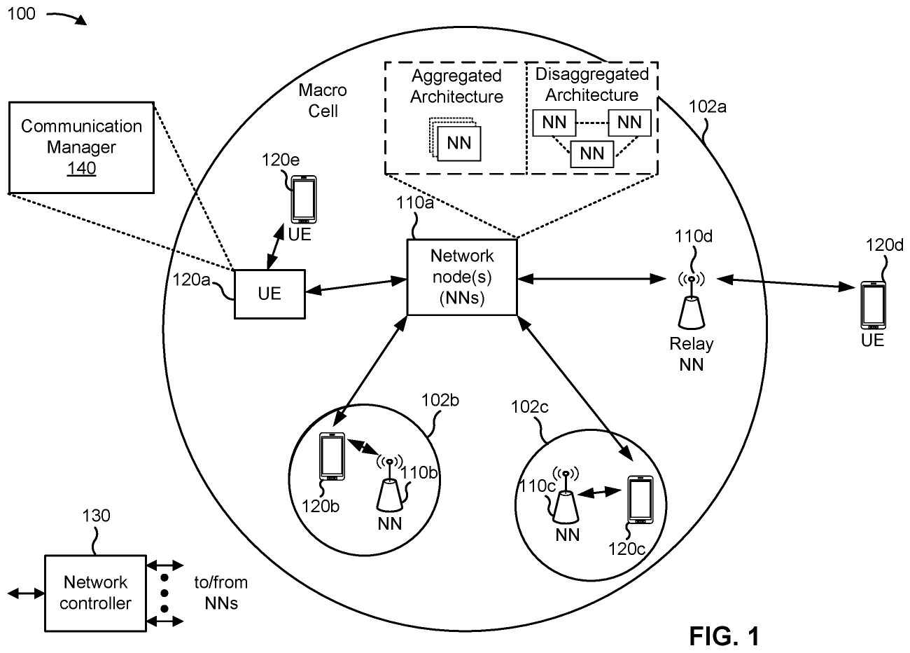

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In 3GPP, the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of a set of SSBs; may receive an indication of a set of PCIs associated with the set of SSBs, where the set of PCIs are stored in association with the set of SSBs; and may refrain from performing a measurement on a first SSB, in the set of SSBs, where the first SSB is associated with a same PCI, in the set of PCIs, as a second SSB that is included in the set of SSBs and is measured. Additionally, or alternatively, the communication manager 140 may receive an indication of a set of SSBs; may receive an indication of a set of PCIs associated with the set of SSBs, where the set of PCIs are stored in association with the set of SSBs; and may perform measurements on a subset of SSBs, in the set of SSBs, where the subset is selected to maximize a quantity of PCIs, in the set of PCIs, that are associated with the subset of SSBs. Additionally, or alternatively, the communication manager 140 may perform one or more other operations described herein.

As indicated above, FIG. 1 is provided as an example. Other examples may differ from what is described with regard to FIG. 1.

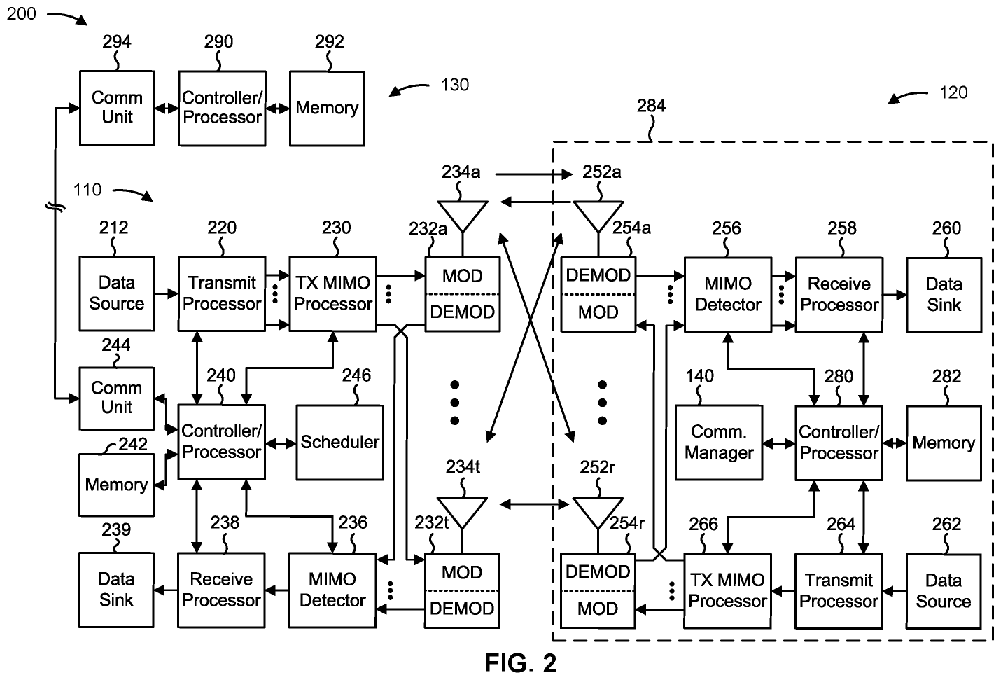

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more Dus.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a PSS or an SSS). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

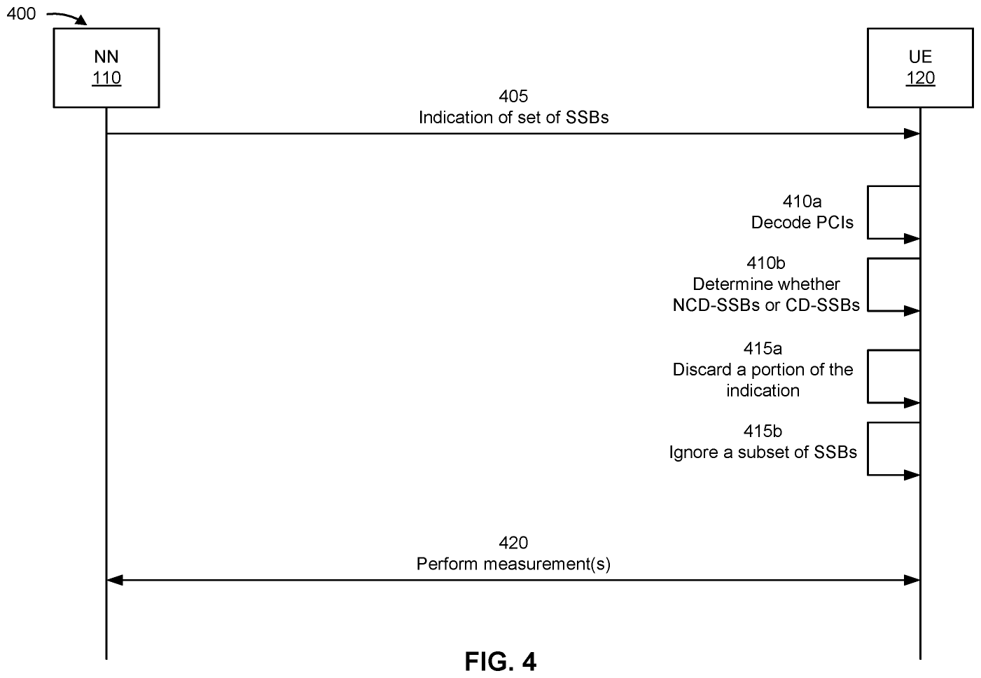

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the network node 110, the uplink signals from UE 120 and/or other Ues may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more Ues 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

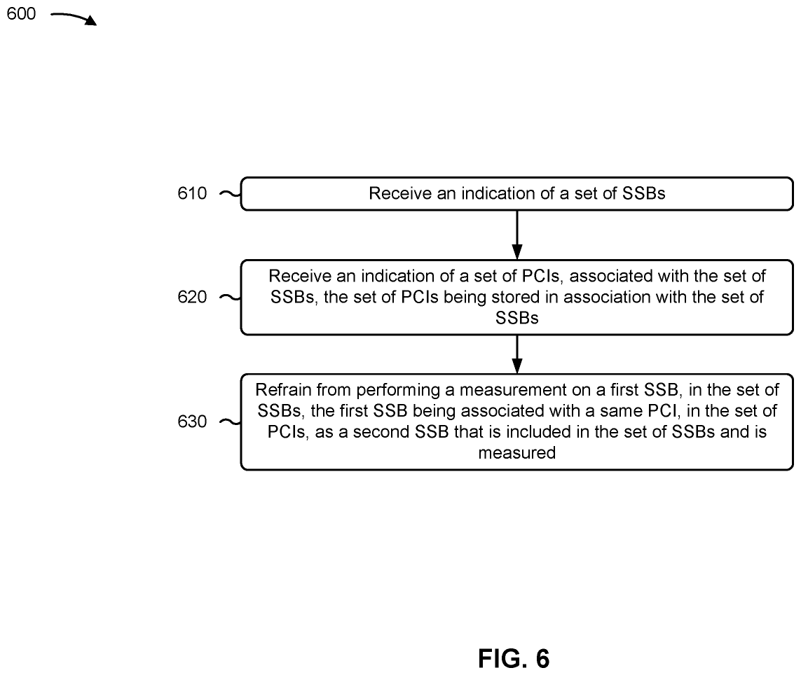

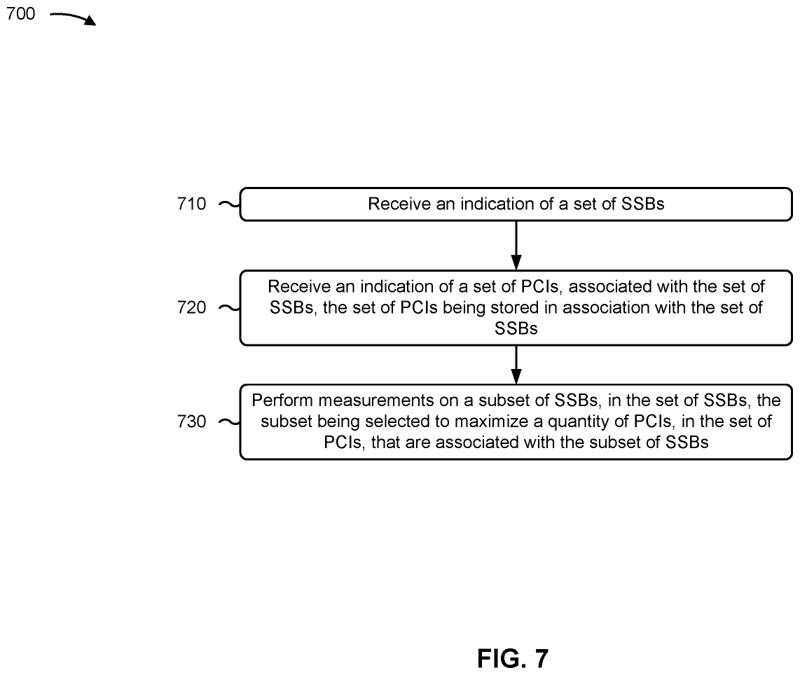

The controller/processor 240 of the network node 110, the controller/processor 280 of the UE 120, and/or any other component(s) of FIG. 2 may perform one or more techniques associated with measurement prioritization by cell, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

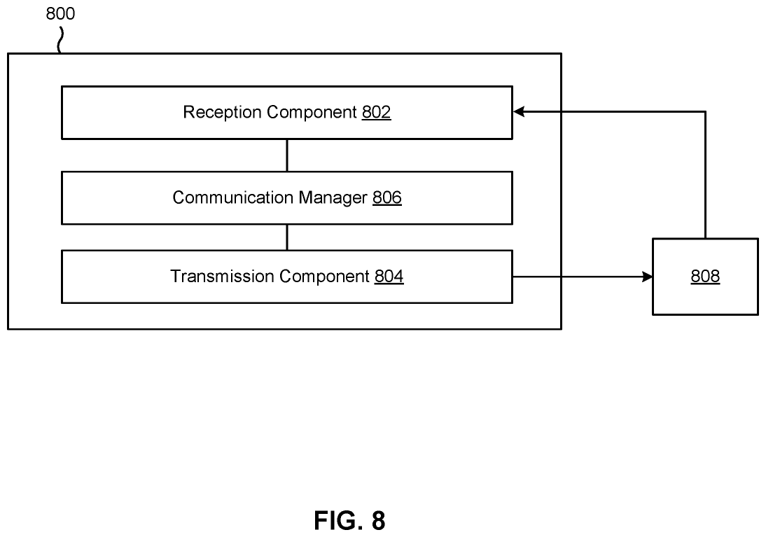

In some aspects, a UE (e.g., the UE 120 and/or apparatus 800 of FIG. 8) may include means for receiving an indication of a set of SSBs; means for receiving an indication of a set of PCIs associated with the set of SSBs, wherein the set of PCIs are stored in association with the set of SSBs; and/or means for refraining from performing a measurement on a first SSB, in the set of SSBs, wherein the first SSB is associated with a same PCI, in the set of PCIs, as a second SSB that is included in the set of SSBs and is measured. Additionally, or alternatively, the UE may include means for receiving an indication of a set of SSBs; means for receiving an indication of a set of PCIs associated with the set of SSBs, wherein the set of PCIs are stored in association with the set of SSBs; and/or means for performing measurements on a subset of SSBs, in the set of SSBs, wherein the subset is selected to maximize a quantity of PCIs, in the set of PCIs, that are associated with the subset of SSBs. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

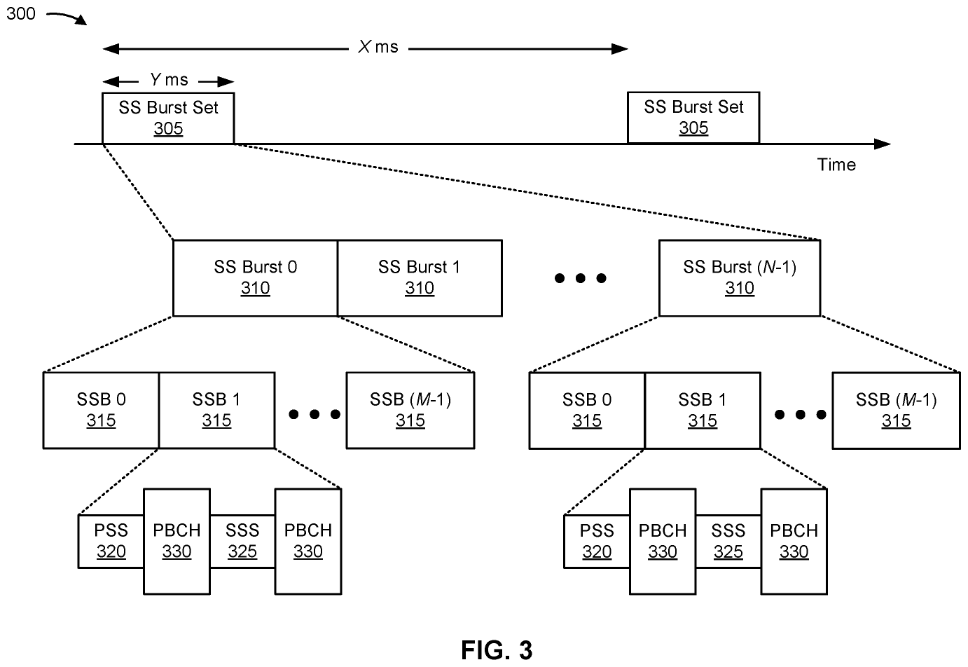

FIG. 3 is a diagram illustrating an example 300 of a synchronization signal (SS) hierarchy, in accordance with the present disclosure. As shown in FIG. 3, the SS hierarchy may include an SS burst set 305, which may include multiple SS bursts 310, shown as SS burst 0 through SS burst N−1, where N is a maximum number of repetitions of the SS burst 310 that may be transmitted by one or more network nodes. As further shown, each SS burst 310 may include one or more SS blocks (SSBs) 315, shown as SSB 0 through SSB M−1, where M is a maximum number of SSBs 315 that can be carried by an SS burst 310. In some aspects, different SSBs 315 may be beam-formed differently (e.g., transmitted using different beams), and may be used for cell search, cell acquisition, beam management, and/or beam selection (e.g., as part of an initial network access procedure). An SS burst set 305 may be periodically transmitted by a wireless node (e.g., a network node 110), such as every X milliseconds (ms), as shown in FIG. 3. In some aspects, an SS burst set 305 may have a fixed or dynamic length, shown as Y ms in FIG. 3. In some cases, an SS burst set 305 or an SS burst 310 may be referred to as a discovery reference signal (DRS) transmission window or an SSB measurement time configuration (SMTC) window.

In some aspects, an SSB 315 may include resources that carry a PSS 320, an SSS 325, and/or a physical broadcast channel (PBCH) 330. In some aspects, multiple SSBs 315 are included in an SS burst 310 (e.g., with transmission on different beams), and the PSS 320, the SSS 325, and/or the PBCH 330 may be the same across each SSB 315 of the SS burst 310. In some aspects, a single SSB 315 may be included in an SS burst 310. In some aspects, the SSB 315 may be at least four symbols (e.g., OFDM symbols) in length, where each symbol carries one or more of the PSS 320 (e.g., occupying one symbol), the SSS 325 (e.g., occupying one symbol), and/or the PBCH 330 (e.g., occupying two symbols). In some aspects, an SSB 315 may be referred to as an SS/PBCH block.

In some aspects, the symbols of an SSB 315 are consecutive, as shown in FIG. 3. In some aspects, the symbols of an SSB 315 are non-consecutive. Similarly, in some aspects, one or more SSBs 315 of the SS burst 310 may be transmitted in consecutive radio resources (e.g., consecutive symbols) during one or more slots. Additionally, or alternatively, one or more SSBs 315 of the SS burst 310 may be transmitted in non-consecutive radio resources.

In some aspects, the SS bursts 310 may have a burst period, and the SSBs 315 of the SS burst 310 may be transmitted by a wireless node (e.g., a network node 110) according to the burst period. In this case, the SSBs 315 may be repeated during each SS burst 310. In some aspects, the SS burst set 305 may have a burst set periodicity, whereby the SS bursts 310 of the SS burst set 305 are transmitted by the wireless node according to the fixed burst set periodicity. In other words, the SS bursts 310 may be repeated during each SS burst set 305.

In some aspects, an SSB 315 may include an SSB index, which may correspond to a beam used to carry the SSB 315. A UE 120 may monitor for and/or measure SSBs 315 using different receive (Rx) beams during an initial network access procedure and/or a cell search procedure, among other examples. Based at least in part on the monitoring and/or measuring, the UE 120 may indicate one or more SSBs 315 with a best signal parameter (e.g., a reference signal received power (RSRP) parameter) to a network node 110 (e.g., directly or via one or more other network nodes). The network node 110 and the UE 120 may use the one or more indicated SSBs 315 to select one or more beams to be used for communication between the network node 110 and the UE 120 (e.g., for a random access channel (RACH) procedure). Additionally, or alternatively, the UE 120 may use the SSB 315 and/or the SSB index to determine a cell timing for a cell via which the SSB 315 is received (e.g., a serving cell).

An SSB may encode a PCI of a cell associated with the SSB. Additionally, an SSB may be a CD-SSB or an NCD-SSB. However, a network generally does not indicate a PCI associated with an SSB (or whether the SSB is a CD-SSB or an NCD-SSB) when configuring a UE to measure the SSB (e.g., using a MeasObject, as defined in 3GPP specifications). Therefore, when memory overhead is high, the UE may discard measurement configurations without awareness of which PCIs correspond to the discarded measurement configurations (and without awareness of whether the discarded measurement configurations are associated with CD-SSBs or NCD-SSBs). As a result, the UE may reduce the network's ability to perform effective handover by discarding all measurement configurations associated with a candidate cell for handover. Reduced ability to perform handover may result in the UE performing cell re-selection when the UE moves out of range of a current serving cell. Cell re-selection costs more power and processing resources than handover.

Some techniques and apparatuses described herein enable a UE to store a set of PCIs in association with a set of SSBs. For example, a UE 120 (such as a RedCap UE) may receive an indication of the set of SSBs (e.g., in MeasObjects from a network node 110) and may decode the set of PCIs from the set of SSBs. Therefore, the UE 120 may discard some measurement configurations while maximizing a quantity of PCIs, in the set of PCIs, that are associated with remaining measurement configurations. As a result, the UE 120 improves the ability of the network node 110 to perform handover, which conserves power and processing resources as compared with performing cell re-selection. Some techniques and apparatuses described herein enable a UE to store an indication of whether each SSB, in a set of SSBs, is a CD-SSB or an NCD-SSB.

Therefore, the UE 120 may prioritize measurement configurations that are associated with CD-SSBs. As a result, the UE 120 may conserve power and processing resources, that otherwise would have been spent on measurements, while preserving the ability of the network node 110 to perform handover.

As indicated above, FIG. 3 is provided as an example. Other examples may differ from what is described with regard to FIG. 3.

FIG. 4 is a diagram illustrating an example 400 associated with measurement prioritization by cell, in accordance with the present disclosure. As shown in FIG. 4, a network node 110 (e.g., an RU and/or a device controlling the RU, such as a DU and/or a CU) and a UE 120 may communicate with one another (e.g., on a wireless network, such as wireless network 100 of FIG. 1).

As shown by reference number 405, the network node 110 may transmit (e.g., directly or via an RU), and the UE 120 may receive, an indication of a set of SSBs. For example, the indication of the set of SSBs may include a set of MeasObjects (e.g., as defined in 3GPP specifications). The indication of the set of SSBs may be included in one or more radio resource control (RRC) messages.

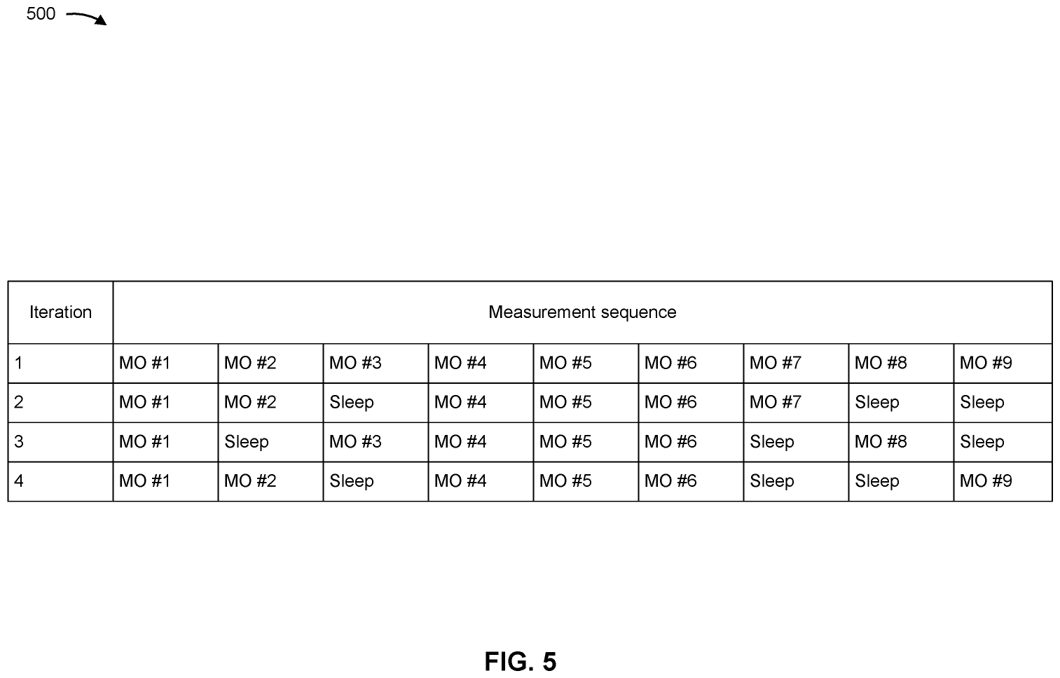

The UE 120 may receive indication of a set of PCIs associated with the set of SSBs. For example, as shown by reference number 410a, the UE 120 may receive each SSB in the set of SSBs (e.g., as described in connection with measurement iteration 1 in FIG. 5) and may decode a PCI, in the set of PCIs, from each SSB. In some aspects, the UE 120 may deduce the PCI, for each SSB, from the PSS (and/or the SSS) inside the SSB).

The UE 120 may store the set of PCIs in association with the set of SSBs. For example, the UE 120 may store the set of PCIs in association with a set of absolute radio-frequency channel numbers (ARFCNs) that correspond to the set of SSBs. In some aspects, the UE 120 may store the set of PCIs, in association with the set of SSBs, in a tabular data structure. For example, the UE 120 may store a table similar to Example Table 1:

EXAMPLE TABLE 1

| PCI | SSB |
|---|---|
| 1 | ARFCN A, B, C, D, E |
| 2 | ARFCN K, L, M, N |

Although described in connection with a tabular data structure, the UE 120 may use an alternative data structure (e.g., another relational structure, such as a graph representation, or another type of associational structure, such as a NoSQL database).

Therefore, the UE 120 maintains a database that has PCI to ARFCN mappings. In some aspects, the UE 120 may additionally or alternatively receive an indication of whether each SSB, in the set of SSBs, is a CD-SSB or an NCD-SSB. For example, as shown by reference number 410b, the UE 120 may determine whether each SSB is a CD-SSB or an NCD-SSB by decoding a subcarrier offset, from each SSB, that indicates whether the SSB is a CD-SSB or an NCD-SSB. In FR1, the UE 120 may measure a frequency configured using MeasObject, may decode SSB content, and may figure out whether the SSB is a CD-SSB or NCD-SSB based on a k_{SSB} value (e.g., if k_{SSB}≤23, the SSB is a CD-SSB, else the SSB is an NCD-SSB).

The UE 120 may further store the indication of whether each SSB is a CD-SSB or an NCD-SSB in association with the set of SSBs. In some aspects, the UE 120 may store the indication of whether each SSB is a CD-SSB or an NCD-SSB, in association with the set of SSBs, in a tabular data structure. For example, the UE 120 may store a table similar to Example Table 2:

EXAMPLE TABLE 2

| PCI | CD-SSB | NCD-SSB |
|---|---|---|
| 1 | ARFCN A | ARFCN B, C, D, E |
| 2 | ARFCN K | ARFCN L, M, N |

Although described in connection with a tabular data structure, the UE 120 may use an alternative data structure (e.g., another relational structure, such as a graph representation, or another type of associational structure, such as a NoSQL database).

Therefore, the UE 120 has knowledge about different PCIs and the ARFCNs of CD-SSBs and NCD-SSBs associated with the PCIs.

In some aspects, as shown by reference number 415a, the UE 120 may discard a portion of the indication. For example, the UE 120 may discard a portion, of the indication of the set of SSBs, that corresponds to a subset, of the set of SSBs, that are NCD-SSBs. In other words, the UE 120 may retain all CD-SSBs first and then retain any NCD-SSBs based on memory overhead available to the UE 120. Additionally, or alternatively, the UE 120 may discard a portion, of the indication of the set of SSBs, corresponding to a subset of the set of SSBs, such that remaining SSBs in the set of SSBs are associated with all PCIs in the set of PCIs. In other words, the UE 120 may prune MeasObjects using the database (that has PCI to ARFCN mappings) and retain one (or a few) MeasObjects mapped to each PCI, rather than blindly pruning MeasObjects. As a result, the UE 120 refrains from ignoring a PCI altogether, and the network node 110 may use measurement reports from the UE 120 to trigger handover to any cell represented in the set of PCIs.

Additionally, or alternatively, as shown by reference number 415b, the UE 120 may refrain from measurement of one or more SSBs. For example, the UE 120 may determine that a measurement associated with a serving cell satisfies a relaxation threshold and may refrain from measuring more than one SSB, in the set of SSBs, for each PCI in the set of PCIs (e.g., based on the measurement satisfying the relaxation threshold). In other words, when serving cell radio conditions are good (also referred to as “excellent mode” in 3GPP specifications), the UE 120 may perform RRM relaxation such that the UE 120 schedules one measurement per PCI (e.g., in total or per measurement round, as described in connection with FIG. 4). Additionally, or alternatively, the UE 120 may determine that a measurement associated with a serving cell satisfies a relaxation threshold and may refrain from measuring one or more SSBs, in the set of SSBs, that are NCD-SSBs (e.g., based on the measurement satisfying the relaxation threshold). In other words, when serving cell radio conditions are good, the UE 120 may perform RRM relaxation such that the UE 120 measures CD-SSBs rather than NCD-SSBs.

As shown by reference number 420, the UE 120 may perform measurements based on the set of PCIs (and/or the indication of whether each SSB is a CD-SSB or an NCD-SSB). For example, the UE 120 may perform a plurality of measurement rounds, where each measurement round includes a different subset of the set of SSBs associated with all PCIs in the set of PCIs, as described in connection with FIG. 5. In some aspects, the UE 120 may perform measurements on a subset of SSBs, in the set of SSBs, where the UE 120 selects the subset to maximize a quantity of PCIs, in the set of PCIs, that are associated with the subset of SSBs. For example, 3GPP specifications may force the UE 120 to select measurement occasions (MOs) (e.g., at least 14 MOs or another minimum number of MOs) to maximize a number of measured physical cells.

In some aspects, the UE 120 may move outside a range associated with a current serving cell. Accordingly, the UE 120 may initialize a connection to a cell that is indicated in an acquisition list and is associated with a PCI in the set of PCIs. The acquisition list may store entries of cells on which the UE 120 previously camped but may fail to indicate which cells support RedCap. Therefore, the UE 120 may prioritize cells that are included in both an acquisition database and in the database that has PCI to ARFCN mappings (that is, cells that are common to both databases). As a result, when the UE 120 is a RedCap UE, the UE 120 may camp faster on cells that are associated with NCD-SSBs (and thus are RedCap configured).

By using techniques as described in connection with FIG. 4, the UE 120 may discard the portion of the indication of the set of SSBs while increasing a quantity of PCIs, in the set of PCIs, that are associated with measurements performed by the UE 120. As a result, the UE 120 improves the ability of the network node 110 to perform handover, which conserves power and processing resources as compared with performing cell re-selection.

As indicated above, FIG. 4 is provided as an example. Other examples may differ from what is described with respect to FIG. 4.

FIG. 5 is a diagram illustrating an example 500 associated with measurement rounds, in accordance with the present disclosure. As shown in FIG. 5, a UE (e.g., UE 120) may be configured with a plurality of MOs (e.g., associated with a plurality of MeasObjects from a network node 110). Although the example 500 is described in connection with 9 MOs, other examples may include fewer MOs (e.g., 8 MOs, 7 MOs, and so on) or additional MOs (e.g., 10 MOs, 11 MOs, and so on).

As shown in FIG. 5, the UE 120 may perform an initial measurement round (e.g., shown as measurement iteration 1) using all MOs in order to decode a PCI from each SSB (and, in some aspects, to determine whether the SSB is a CD-SSB or an NCD-SSB, as described in connection with FIG. 4). Therefore, the UE 120 may store a set of PCIs in association with a set of SSBs (where each SSB is associated with a corresponding MO).

Using the set of PCIs, the UE 120 may perform a plurality of measurement rounds, where each measurement round includes a different subset of the set of SSBs associated with all PCIs in the set of PCIs. In other words, the UE 120 may group the SSBs mapped to a same PCI to reduce power and processing resources expended on measurement. In the example 500, MOs #2 and #3 are associated with a same PCI and thus are grouped. The UE 120 may therefore perform round robin measurements in MO #2 and MO #3 across measurement iterations (e.g., measure only one entry in the group in one iteration and measure another entry in the group in a next iteration). Additionally, in the example 500, MOs #7, #8, and #9 are associated with a same PCI and thus are grouped. The UE 120 may therefore perform round robin measurements in MO #7, MO #8, and MO #9 across measurement iterations. Remaining gap periods may allow for the UE 120 to sleep (e.g., execute fewer, if any, processing cycles and/or reduce power to some hardware, such as an antenna or another portion of an Rx chain).

In some aspects, the UE 120 may select the plurality of measurement rounds based on similar measurement metrics between SSBs, in the set of SSBs, associated with a same PCI. In other words, the UE 120 may group the SSBs mapped to a same PCI and that are giving similar measurement metrics (e.g., RSRP values, RSRQ values, and/or signal-to-interference-and-noise ratios (SINRs) that are different from each other by an amount that satisfies a similarity threshold). In the example 500, then, MOs #2 and #3 may be associated with a same PCI and give similar measurement metrics in a previous n instances. Similarly, MOs #7, #8, and #9 may be associated with a same PCI and give similar measurement metrics in a previous n instances.

By using techniques as described in connection with FIG. 5, the UE 120 may conserve power and processing resources, that otherwise would have been spent on measurements, while preserving the ability of the network node 110 to perform handover.

As indicated above, FIG. 5 is provided as an example. Other examples may differ from what is described with respect to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120 and/or apparatus 800 of FIG. 8) performs operations associated with measurement prioritization by cell.

As shown in FIG. 6, in some aspects, process 600 may include receiving an indication of a set of SSBs (block 610). For example, the UE (e.g., using reception component 802 and/or communication manager 806, depicted in FIG. 8) may receive an indication of a set of SSBs, as described herein.

As further shown in FIG. 6, in some aspects, process 600 may include receiving an indication of a set of PCIs associated with the set of SSBs, the set of PCIs being stored in association with the set of SSBs (block 620). For example, the UE (e.g., using reception component 802 and/or communication manager 806) may receive an indication of a set of PCIs associated with the set of SSBs, the set of PCIs being stored in association with the set of SSBs, as described herein.

As further shown in FIG. 6, in some aspects, process 600 may include refraining from performing a measurement on a first SSB, in the set of SSBs, the first SSB being associated with a same PCI, in the set of PCIs, as a second SSB that is included in the set of SSBs and is measured (block 630). For example, the UE (e.g., using reception component 802 and/or communication manager 806) may refrain from performing a measurement on a first SSB, in the set of SSBs, the first SSB being associated with a same PCI, in the set of PCIs, as a second SSB that is included in the set of SSBs and is measured, as described herein.

Process 600 may include additional aspects, such as any single aspect or any combination of aspects described below and/or in connection with one or more other processes described elsewhere herein.

In a first aspect, the indication of the set of SSBs includes a set of MeasObjects.

In a second aspect, alone or in combination with the first aspect, receiving the indication of the set of PCIs includes receiving each SSB in the set of SSBs, and decoding a PCI, in the set of PCIs, from each SSB.

In a third aspect, alone or in combination with one or more of the first and second aspects, the set of PCIs are stored in association with a set of ARFCNs, where the set of ARFCNs correspond to the set of SSBs.

In a fourth aspect, alone or in combination with one or more of the first through third aspects, process 600 includes receiving (e.g., using reception component 802 and/or communication manager 806) an indication of whether each SSB, in the set of SSBs, is a CD-SSB or an NCD-SSB, and the indication of whether each SSB is a CD-SSB or an NCD-SSB is stored in association with the set of SSBs.

In a fifth aspect, alone or in combination with one or more of the first through fourth aspects, process 600 includes discarding (e.g., using communication manager 806) a portion, of the indication of the set of SSBs, that corresponds to a subset, of the set of SSBs, that are NCD-SSBs.

In a sixth aspect, alone or in combination with one or more of the first through fifth aspects, process 600 includes determining (e.g., using communication manager 806) that a measurement associated with a serving cell satisfies a relaxation threshold, and refraining from measuring (e.g., using reception component 802 and/or communication manager 806) one or more SSBs, in the set of SSBs, that are NCD-SSBs.

In a seventh aspect, alone or in combination with one or more of the first through sixth aspects, receiving the indication of whether each SSB is a CD-SSB or an NCD-SSB includes receiving each SSB in the set of SSBs, and decoding a subcarrier offset, from each SSB, that indicates whether the SSB is a CD-SSB or an NCD-SSB.

In an eighth aspect, alone or in combination with one or more of the first through seventh aspects, process 600 includes performing a plurality of measurement rounds (e.g., using reception component 802 and/or communication manager 806), where each measurement round includes a different subset of the set of SSBs associated with all PCIs in the set of PCIs.

In a ninth aspect, alone or in combination with one or more of the first through eighth aspects, the plurality of measurement rounds are selected based on similar measurement metrics between SSBs, in the set of SSBs, associated with a same PCI.

In a tenth aspect, alone or in combination with one or more of the first through ninth aspects, process 600 includes discarding (e.g., using communication manager 806) a portion, of the indication of the set of SSBs, corresponding to a subset of the set of SSBs, such that remaining SSBs in the set of SSBs are associated with all PCIs in the set of PCIs.

In an eleventh aspect, alone or in combination with one or more of the first through tenth aspects, process 600 includes determining (e.g., using communication manager 806) that a measurement associated with a serving cell satisfies a relaxation threshold, and refraining from measuring (e.g., using reception component 802 and/or communication manager 806) more than one SSB, in the set of SSBs, for each PCI in the set of PCIs.

In a twelfth aspect, alone or in combination with one or more of the first through eleventh aspects, process 600 includes initializing a connection to a cell (e.g., using transmission component 804 and/or communication manager 806, depicted in FIG. 8), where the cell is indicated in an acquisition list and is associated with a PCI in the set of PCIs.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a UE or an apparatus of a UE, in accordance with the present disclosure. Example process 700 is an example where the apparatus or the UE (e.g., UE 120 and/or apparatus 800 of FIG. 8) performs operations associated with measurement prioritization by cell.

As shown in FIG. 7, in some aspects, process 700 may include receiving an indication of a set of SSBs (block 710). For example, the UE (e.g., using reception component 802 and/or communication manager 806, depicted in FIG. 8) may receive an indication of a set of SSBs, as described herein.

As further shown in FIG. 7, in some aspects, process 700 may include receiving an indication of a set of PCIs associated with the set of SSBs, the set of PCIs being stored in association with the set of SSBs (block 720). For example, the UE (e.g., using reception component 802 and/or communication manager 806, depicted in FIG. 8) may receive an indication of a set of PCIs associated with the set of SSBs, the set of PCIs being stored in association with the set of SSBs, as described herein.

As further shown in FIG. 7, in some aspects, process 700 may include performing measurements on a subset of SSBs, in the set of SSBs, the subset being selected to maximize a quantity of PCIs, in the set of PCIs, that are associated with the subset of SSBs (block 730). For example, the UE (e.g., using communication manager 806, depicted in FIG. 8) may perform measurements on a subset of SSBs, in the set of SSBs, the subset being selected to maximize a quantity of PCIs, in the set of PCIs, that are associated with the subset of SSBs, as described herein.

Process 700 may include additional aspects, such as any single aspect or any combination of aspects described below and/or in connection with one or more other processes described elsewhere herein.

In a first aspect, the indication of the set of SSBs includes a set of MeasObjects.

In a second aspect, alone or in combination with the first aspect, receiving the indication of the set of PCIs includes receiving each SSB in the set of SSBs, and decoding a PCI, in the set of PCIs, from each SSB.

In a third aspect, alone or in combination with one or more of the first and second aspects, the set of PCIs are stored in association with a set of ARFCNs, where the set of ARFCNs correspond to the set of SSBs.

In a fourth aspect, alone or in combination with one or more of the first through third aspects, process 700 includes discarding (e.g., using communication manager 806) a portion, of the indication of the set of SSBs, corresponding to remaining SSBs that are in the set of SSBs and excluded from the subset of SSBs.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 4-5. Additionally, or alternatively, the apparatus 800 may be configured to perform one or more processes described herein, such as process 600 of FIG. 6, process 700 of FIG. 7, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 804 may be co-located with the reception component 802 in one or more transceivers.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

In some aspects, the reception component 802 may receive (e.g., from the apparatus 808) an indication of a set of SSBs and may receive an indication of a set of PCIs associated with the set of SSBs. The set of PCIs may be stored (e.g., by the communication manager 806) in association with the set of SSBs. Accordingly, the reception component 802 and/or the communication manager 806 may refrain from performing a measurement on a first SSB, in the set of SSBs, based on the first SSB being associated with a same PCI, in the set of PCIs, as a second SSB that is included in the set of SSBs and is measured. Additionally, or alternatively, the reception component 802 and/or the communication manager 806 may perform measurements on a subset of SSBs, in the set of SSBs, where the subset is selected to maximize a quantity of PCIs, in the set of PCIs, that are associated with the subset of SSBs. Therefore, the communication manager 806 may discard a portion, of the indication of the set of SSBs, corresponding to remaining SSBs that are in the set of SSBs and excluded from the subset of SSBs.

In some aspects, the reception component 802 may receive an indication of whether each SSB, in the set of SSBs, is a CD-SSB or an NCD-SSB. The indication of whether each SSB is a CD-SSB or an NCD-SSB may be stored (e.g., by the communication manager 806) in association with the set of SSBs. Therefore, the communication manager 806 may discard a portion, of the indication of the set of SSBs, that corresponds to a subset, of the set of SSBs, that are NCD-SSBs.

In some aspects, the communication manager 806 may determine that a measurement associated with a serving cell satisfies a relaxation threshold. Therefore, the reception component 802 and/or the communication manager 806 may refrain from measuring one or more SSBs, in the set of SSBs, that are NCD-SSBs. Additionally, or alternatively, the reception component 802 and/or the communication manager 806 may refrain from measuring more than one SSB, in the set of SSBs, for each PCI in the set of PCIs.

In some aspects, the reception component 802 and/or the communication manager 806 may perform a plurality of measurement rounds, where each measurement round includes a different subset of the set of SSBs associated with all PCIs in the set of PCIs. Additionally, or alternatively, the communication manager 806 may discard a portion, of the indication of the set of SSBs, corresponding to a subset of the set of SSBs, where remaining SSBs in the set of SSBs are associated with all PCIs in the set of PCIs.

In some aspects, the transmission component 804 and/or the communication manager 806 may initialize a connection to a cell based on the cell being indicated in an acquisition list and being associated with a PCI in the set of PCIs.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

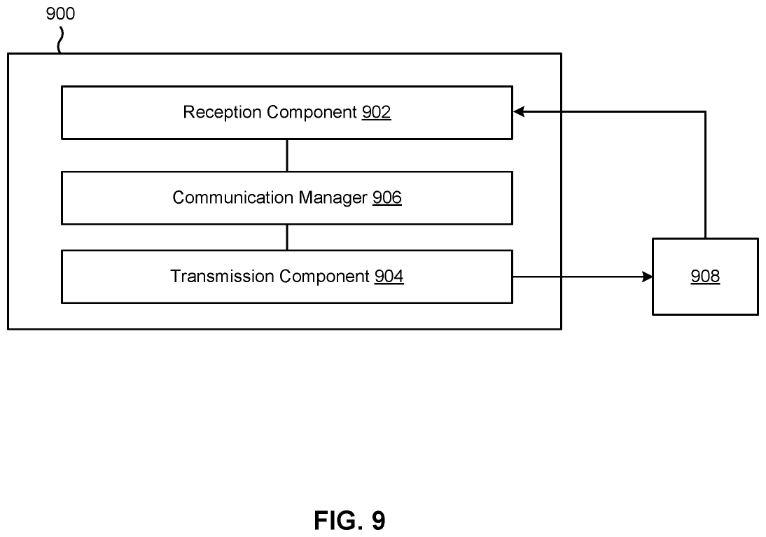

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4-5. Additionally, or alternatively, the apparatus 900 may be configured to perform one or more processes described herein, or a combination thereof. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

In some aspects, the transmission component 904 may transmit (e.g., to the apparatus 908) an indication of a set of SSBs (that are implicitly associated with a set of PCIs). The reception component 902 may receive (e.g., from the apparatus 908) one or more measurement reports associated with a subset of SSBs, in the set of SSBs. For example, the subset may have been selected to maximize a quantity of PCIs, in the set of PCIs, that are associated with the subset of SSBs.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving an indication of a set of synchronization signal blocks (SSBs); receiving an indication of a set of physical cell identifiers (PCIs) associated with the set of SSBs, wherein the set of PCIs are stored in association with the set of SSBs; and refraining from performing a measurement on a first SSB, in the set of SSBs, wherein the first SSB is associated with a same PCI, in the set of PCIs, as a second SSB that is included in the set of SSBs and is measured.

Aspect 2: The method of Aspect 1, wherein the indication of the set of SSBs comprises a set of MeasObjects.

Aspect 3: The method of any of Aspects 1-2, wherein the receiving the indication of the set of PCIs comprises: receiving each SSB in the set of SSBs; and decoding a PCI, in the set of PCIs, from each SSB.

Aspect 4: The method of any of Aspects 1-3, wherein the set of PCIs are stored in association with a set of absolute radio-frequency channel numbers (ARFCNs), wherein the set of ARFCNs correspond to the set of SSBs.

Aspect 5: The method of any of Aspects 1-4, further comprising: receiving an indication of whether each SSB, in the set of SSBs, is a cell-defining SSB (CD-SSB) or a non-cell-defining SSB (NCD-SSB), wherein the indication of whether each SSB is a CD-SSB or an NCD-SSB is stored in association with the set of SSBs.

Aspect 6: The method of Aspect 5, further comprising: discarding a portion, of the indication of the set of SSBs, that corresponds to a subset, of the set of SSBs, that are NCD-SSBs.

Aspect 7: The method of any of Aspects 5-6, further comprising: determining that a measurement associated with a serving cell satisfies a relaxation threshold; and refraining from measuring one or more SSBs, in the set of SSBs, that are NCD-SSBs.

Aspect 8: The method of any of Aspects 5-7, wherein the receiving the indication of whether each SSB is a CD-SSB or an NCD-SSB comprises: receiving each SSB in the set of SSBs; and decoding a subcarrier offset, from each SSB, that indicates whether the SSB is a CD-SSB or an NCD-SSB.

Aspect 9: The method of any of Aspects 1-8, further comprising: performing a plurality of measurement rounds, wherein each measurement round includes a different subset of the set of SSBs associated with all PCIs in the set of PCIs.

Aspect 10: The method of Aspect 9, wherein the plurality of measurement rounds are selected based on similar measurement metrics between SSBs, in the set of SSBs, associated with a same PCI.

Aspect 11: The method of any of Aspects 1-10, further comprising: discarding a portion, of the indication of the set of SSBs, corresponding to a subset of the set of SSBs, wherein remaining SSBs in the set of SSBs are associated with all PCIs in the set of PCIs.

Aspect 12: The method of any of Aspects 1-11, further comprising:
determining that a measurement associated with a serving cell satisfies a relaxation threshold; and refraining from measuring more than one SSB, in the set of SSBs, for each PCI in the set of PCIs.

Aspect 13: The method of any of Aspects 1-12, further comprising: initializing a connection to a cell, wherein the cell is indicated in an acquisition list and is associated with a PCI in the set of PCIs.

Aspect 14: A method of wireless communication performed by a user equipment (UE), comprising: receiving an indication of a set of synchronization signal blocks (SSBs); receiving an indication of a set of physical cell identifiers (PCIs) associated with the set of SSBs, wherein the set of PCIs are stored in association with the set of SSBs; and performing measurements on a subset of SSBs, in the set of SSBs, wherein the subset is selected to maximize a quantity of PCIs, in the set of PCIs, that are associated with the subset of SSBs.

Aspect 15: The method of Aspect 14, wherein the indication of the set of SSBs comprises a set of MeasObjects.

Aspect 16: The method of any of Aspects 14-15, wherein the receiving the indication of the set of PCIs comprises: receiving each SSB in the set of SSBs; and decoding a PCI, in the set of PCIs, from each SSB.

Aspect 17: The method of any of Aspects 14-16, wherein the set of PCIs are stored in association with a set of absolute radio-frequency channel numbers (ARFCNs), wherein the set of ARFCNs correspond to the set of SSBs.

Aspect 18: The method of any of Aspects 14-17, further comprising:
discarding a portion, of the indication of the set of SSBs, corresponding to remaining SSBs that are in the set of SSBs and excluded from the subset of SSBs.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.

Aspect 21: An apparatus for wireless communication, the apparatus comprising at least one means for performing the method of one or more of Aspects 1-18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: A device for wireless communication, comprising one or more memories, and one or more processors coupled to the one or more memories, the one or more memories comprising instructions executable by the one or more processors to cause the device to perform the method of one or more of Aspects 1-18.

Aspect 26: An apparatus for wireless communication at a device, the apparatus comprising one or more memories and one or more processors coupled to the one or more memories, the one or more processors individually or collectively configured to cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors coupled to the one or more memories, the one or more memories comprising instructions executable by the one or more processors to cause the UE to:
receive an indication of a set of synchronization signal blocks (SSBs);
receive an indication of a set of physical cell identifiers (PCIs) associated with the set of SSBs, wherein the set of PCIs are stored in association with the set of SSBs; and
refrain from performing a measurement on a first SSB, in the set of SSBs, wherein the first SSB is associated with a same PCI, in the set of PCIs, as a second SSB that is included in the set of SSBs and is measured.

2. The apparatus of claim 1, wherein the indication of the set of SSBs comprises a set of MeasObjects.

3. The apparatus of claim 1, wherein the instructions, that cause the UE to receive the indication of the set of PCIs, cause the UE to:
receive each SSB in the set of SSBs; and
decode a PCI, in the set of PCIs, from each SSB.

4. The apparatus of claim 1, wherein the set of PCIs are stored in association with a set of absolute radio-frequency channel numbers (ARFCNs), wherein the set of ARFCNs correspond to the set of SSBs.

5. The apparatus of claim 1, wherein the one or more memories further comprise instructions executable by the one or more processors to cause the UE to:
receive an indication of whether each SSB, in the set of SSBs, is a cell-defining SSB (CD-SSB) or a non-cell-defining SSB (NCD-SSB),
wherein the indication of whether each SSB is a CD-SSB or an NCD-SSB is stored in association with the set of SSBs.

6. The apparatus of claim 5, wherein the one or more memories further comprise instructions executable by the one or more processors to cause the UE to:
discard a portion, of the indication of the set of SSBs, that corresponds to a subset, of the set of SSBs, that are NCD-SSBs.

7. The apparatus of claim 5, wherein the one or more memories further comprise instructions executable by the one or more processors to cause the UE to:
determine that a measurement associated with a serving cell satisfies a relaxation threshold; and
refrain from measuring one or more SSBs, in the set of SSBs, that are NCD-SSBs.

8. The apparatus of claim 5, wherein the instructions, that cause the UE to receive the indication of whether each SSB is a CD-SSB or an NCD-SSB, cause the UE to:
receive each SSB in the set of SSBs; and
decode a subcarrier offset, from each SSB, that indicates whether the SSB is a CD-SSB or an NCD-SSB.

9. The apparatus of claim 1, wherein the one or more memories further comprise instructions executable by the one or more processors to cause the UE to:
perform a plurality of measurement rounds, wherein each measurement round includes a different subset of the set of SSBs associated with all PCIs in the set of PCIs.

10. The apparatus of claim 9, wherein the plurality of measurement rounds are selected based on similar measurement metrics between SSBs, in the set of SSBs, associated with a same PCI.

11. The apparatus of claim 1, wherein the one or more memories further comprise instructions executable by the one or more processors to cause the UE to:
discard a portion, of the indication of the set of SSBs, corresponding to a subset of the set of SSBs, wherein remaining SSBs in the set of SSBs are associated with all PCIs in the set of PCIs.

12. The apparatus of claim 1, wherein the one or more memories further comprise instructions executable by the one or more processors to cause the UE to:
determine that a measurement associated with a serving cell satisfies a relaxation threshold; and
refrain from measuring more than one SSB, in the set of SSBs, for each PCI in the set of PCIs.

13. The apparatus of claim 1, wherein the one or more memories further comprise instructions executable by the one or more processors to cause the UE to:
initialize a connection to a cell, wherein the cell is indicated in an acquisition list and is associated with a PCI in the set of PCIs.

14. An apparatus for wireless communication at a user equipment (UE), comprising:
one or more memories; and
one or more processors coupled to the one or more memories, the one or more memories comprising instructions executable by the one or more processors to cause the UE to:
receive an indication of a set of synchronization signal blocks (SSBs);
receive an indication of a set of physical cell identifiers (PCIs) associated with the set of SSBs, wherein the set of PCIs are stored in association with the set of SSBs; and
perform measurements on a subset of SSBs, in the set of SSBs, wherein the subset is selected to maximize a quantity of PCIs, in the set of PCIs, that are associated with the subset of SSBs.

15. The apparatus of claim 14, wherein the indication of the set of SSBs comprises a set of MeasObjects.

16. The apparatus of claim 14, wherein the instructions, that cause the UE to receive the indication of the set of PCIs, cause the UE to:
receive each SSB in the set of SSBs; and
decode a PCI, in the set of PCIs, from each SSB.

17. The apparatus of claim 14, wherein the set of PCIs are stored in association with a set of absolute radio-frequency channel numbers (ARFCNs), wherein the set of ARFCNs correspond to the set of SSBs.

18. The apparatus of claim 14, wherein the one or more memories further comprise instructions executable by the one or more processors to cause the UE to:
discard a portion, of the indication of the set of SSBs, corresponding to remaining SSBs that are in the set of SSBs and excluded from the subset of SSBs.

19. A method of wireless communication performed by a user equipment (UE), comprising:
receiving an indication of a set of synchronization signal blocks (SSBs);
receiving an indication of a set of physical cell identifiers (PCIs) associated with the set of SSBs, wherein the set of PCIs are stored in association with the set of SSBs; and
refraining from performing a measurement on a first SSB, in the set of SSBs, wherein the first SSB is associated with a same PCI, in the set of PCIs, as a second SSB that is included in the set of SSBs and is measured.

20. The method of claim 19, wherein the receiving the indication of the set of PCIs comprises:
receiving each SSB in the set of SSBs; and
decoding a PCI, in the set of PCIs, from each SSB.

21. The method of claim 19, further comprising:
receiving an indication of whether each SSB, in the set of SSBs, is a cell-defining SSB (CD-SSB) or a non-cell-defining SSB (NCD-SSB),
wherein the indication of whether each SSB is a CD-SSB or an NCD-SSB is stored in association with the set of SSBs.

22. The method of claim 21, further comprising:
discarding a portion, of the indication of the set of SSBs, that corresponds to a subset, of the set of SSBs, that are NCD-SSBs.

23. The method of claim 21, wherein the receiving the indication of whether each SSB is a CD-SSB or an NCD-SSB comprises:
receiving each SSB in the set of SSBs; and
decoding a subcarrier offset, from each SSB, that indicates whether the SSB is a CD-SSB or an NCD-SSB.

24. The method of claim 19, further comprising:
performing a plurality of measurement rounds, wherein each measurement round includes a different subset of the set of SSBs associated with all PCIs in the set of PCIs.

25. The method of claim 24, wherein the plurality of measurement rounds are selected based on similar measurement metrics between SSBs, in the set of SSBs, associated with a same PCI.

26. The method of claim 19, further comprising:
discarding a portion, of the indication of the set of SSBs, corresponding to a subset of the set of SSBs, wherein remaining SSBs in the set of SSBs are associated with all PCIs in the set of PCIs.

27. The method of claim 19, further comprising:
initializing a connection to a cell, wherein the cell is indicated in an acquisition list and is associated with a PCI in the set of PCIs.

28. A method of wireless communication performed by a user equipment (UE), comprising:
receiving an indication of a set of synchronization signal blocks (SSBs);
receiving an indication of a set of physical cell identifiers (PCIs) associated with the set of SSBs, wherein the set of PCIs are stored in association with the set of SSBs; and
performing measurements on a subset of SSBs, in the set of SSBs, wherein the subset is selected to maximize a quantity of PCIs, in the set of PCIs, that are associated with the subset of SSBs.

29. The method of claim 28, wherein the receiving the indication of the set of PCIs comprises:
receiving each SSB in the set of SSBs; and
decoding a PCI, in the set of PCIs, from each SSB.

30. The method of claim 28, further comprising:
discarding a portion, of the indication of the set of SSBs, corresponding to remaining SSBs that are in the set of SSBs and excluded from the subset of SSBs.
